(19) United States
(12) Patent Application Publication
(10) Pub. No.: US 2002/0095662 A1
(43) Pub. Date: Jul. 18, 2002

(54) Utilizing powerline networking as a general purpose transport for a variety of signals

(76) Inventors: Robert L. Ashlock, Irvine, CA (US); Chirjeev Singh, Irvine, CA (US); Hossein Alavi, Woodbridge (CA); Mehdi Tavassoli, Mississauga (CA)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/941,255

(22) Filed: Aug. 28, 2001

Related U.S. Application Data
(60) Provisional application No. 60/243,223, filed on Oct. 25, 2000.

(51) Int. Cl. G06F 9/45

(52) U.S. Cl. 717/136

(57) ABSTRACT

One embodiment of the invention relates to a media adapter adapted for coupling a networking device to a power line. This embodiment of the media adapter comprises a physical layer coupled to the power line, a medium access control (MAC) layer in communication with the physical layer, and an inter-working unit in communication with the MAC layer. The inter-working unit is adapted to translate information from a first format into a second format, which differs from the first format, to enable information to be received and transmitted over the power line.

### FIELD

The invention relates to the field of networking. In particular, one embodiment of the invention relates to a network, technique and logic for transmission of voice packets and other signaling types over an existing power line.

### GENERAL BACKGROUND

Wireless telephones and wireless data devices are often utilized when it is not practical to run additional wiring for connectivity or when user mobility is needed. However, it is appreciated that certain wireless architectures, such as a wireless local area network (WLAN), still require some form of actual, dedicated wiring to transport signals out to a base station (referred to herein as an “Access Point”). The extent of such wiring can be quite extensive and restricts flexibility in physical placement of an Access Point.

Originally, power line networking was conceived for the networking and transport of high-speed data in small office and home office environments as shown by a conventional residential network using power line networking of FIG. 1. A typical residence may feature a residential gateway 100 that contains a networking solution to exclusively transport data via an alternating current (AC) power line 110 to attached networking devices such as personal computers (PCs) 120 and 125 or a printer 130. However, the residence would also feature traditional twisted pair wiring 135, separate and apart from the power line 110, to provide voice band services from the local service provider. Likewise, wireless data (and possibly voice) services would be provided to wireless devices over an Ethernet-type connection 140 for example. Thus, for this example, three (3) separate medium types would be implemented within the residence, which is difficult to manage and costly to employ.

### BRIEF DESCRIPTION OF THE DRAWINGS

The features and advantages of the present invention will become apparent from the following detailed description of the present invention in which:

FIG. 1 is a conventional residential network implemented with multiple communication mediums.

FIG. 2 is an exemplary embodiment of a residential network implemented with an AC power line.

FIG. 3A are exemplary embodiments of media adapters for power line networking.

FIG. 3B is an exemplary embodiment of a flowchart of the operations of the media adapter of FIG. 3A.

FIG. 4 is an exemplary embodiment of a network architecture utilizing the present invention.

FIG. 5 is an exemplary embodiment of an inter-working unit (IWU) for interconnecting a wireless LAN protocol network and a HomePlug™ network.

FIG. 6 is an exemplary embodiment of the IWU of FIG. 5 employed within Access Points for requisite protocol conversion.

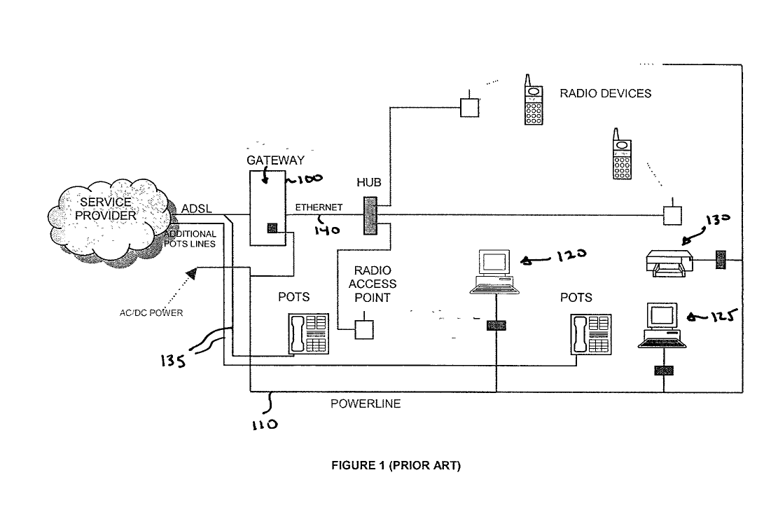

### DETAILED DESCRIPTION

Herein, the exemplary embodiments of the invention relate to a network, technique and logic that enables the transmission of voice packets and other signaling types over a power line. However, these embodiments are not exclusive; rather, they merely provide a thorough understanding of the invention. Well-known circuits are not set forth in detail in order to avoid unnecessarily obscuring the invention.

In particular, certain embodiments of the invention relate to (1) the utilization of power line networking to transport packetized voice to a Plain Old Telephone Service (POTS) telephone station or other POTS devices (e.g. a Group 3 facsimile machine) by creation and use of power line networking-to-POTS media adapters; (2) the utilization of power line networking to transport signals to a wireless Access Point (AP) that enables wireless information and/or wireless telephony (commonly referred to, but not limited to Voice-over-IP and/or Voice-over-DSL) by creation and use of power line media adapters; and/or (3) the creation of a media access control (MAC) layer adaptation and an inter-working unit (IWU) to enable robust and/or contention-free transport of voice packets and other signaling.

In general, the invention provides a number of advantages over traditional networking architectures. For example, the invention eliminates the need to run separate signal transport wiring for wireless Access Points in a wireless local area network (WLAN) or another wireless communication environment. Additionally, the invention eliminates the need to run separate wiring for telephones in a facility (e.g., residence or office environment), enables easier implementation through addition, move or substitution of a networking device, and provides unified management of transport resources.

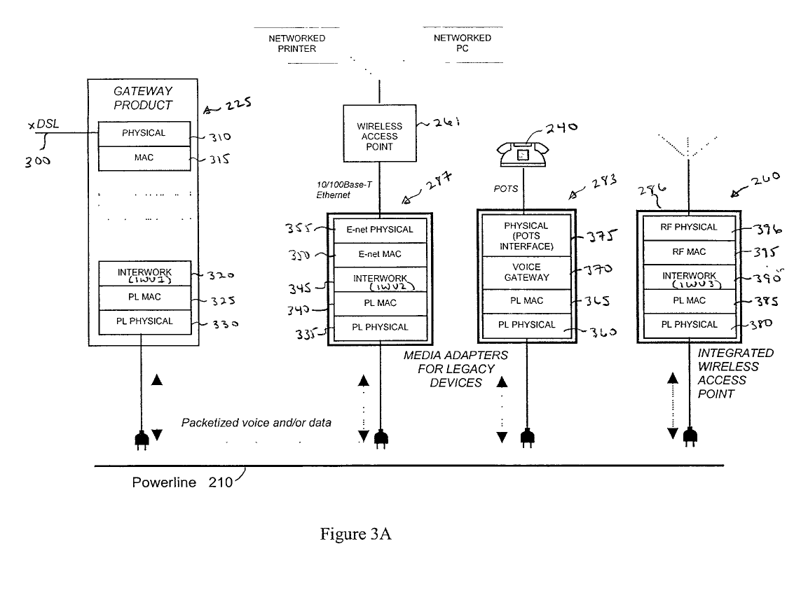

In the following description, certain terminology is used to describe features of the invention. For example, “logic” includes hardware and/or software module(s) that perform a certain function on incoming information. A “software module” includes code that, when executed, performs a certain function. The software module(s) may be stored in a machine readable medium, including but not limited to an electronic circuit, a semiconductor memory device, a read only memory (ROM), a flash memory, an erasable ROM (EROM), a floppy diskette, a compact disk, an optical disk, a hard disk, a fiber optic medium, a radio frequency (RF) link and the like. Such software modules may be executed by a processor (e.g., a microprocessor, a digital signal processor, an application specific integrated circuit, a microcontroller, a state machine, a programmable gate array or any processing circuitry). For example, one embodiment of the logic may include, but is not limited or restricted to a media adapter and/or an inter-working unit (IWU) as described in FIGS. 3 and/or 5.

In addition, a “line” is broadly defines as one or more physical or virtual information-carrying mediums to establish a communication pathway. Examples of the medium include a physical medium (e.g., electrical wire, optical fiber, cable, bus traces, etc.) or a wireless medium (e.g., air in combination with wireless signaling technology). The line enables transportation of packets of information to a networking device coupled thereto. A “networking device” is an Access Point, a POTS telephone station, a computer (e.g., a desktop computer, laptop computer, server, network computer, personal digital assistant, mainframe, etc.), a peripheral device (e.g., a printer, facsimile machine, plotter, etc.) and the like. A “packet” is a collection of bits with one portion (header) being used for routing of the packet and a second portion (payload) being used to contain information intended to be transferred for example. The term “information” is defined as voice, data, video, images and the like.

I. General Architecture

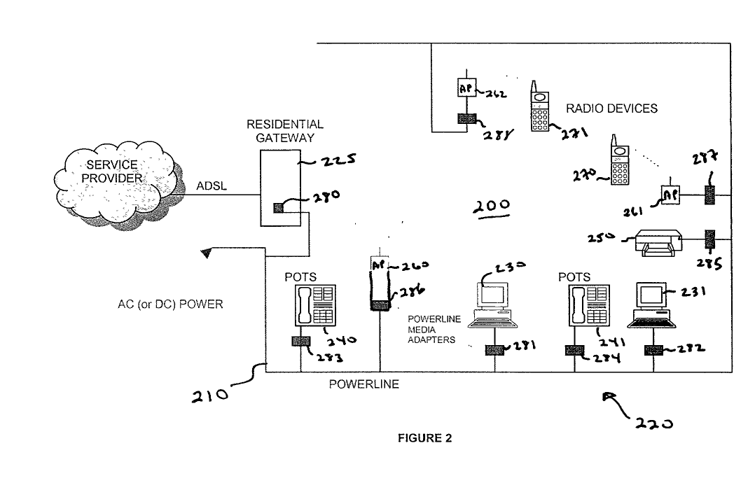

Referring to FIG. 2, an exemplary embodiment of a network utilizing media adapters coupled between a power line and a plurality of networking devices is shown. The network 200 comprises a power line 210, which is electrical wiring that routes power throughout a facility. For this embodiment, the power line 210 may be an alternating current (AC) power line, normally ranging from 110 volts AC (VAC) to 240 VAC. It is contemplated, however, that direct current (DC) power lines could be used in combination with or in lieu of AC power lines.

As shown, the power line 210 is in communication with a plurality of networking devices 220 such as a gateway 225, computers 230-231, POTS telephone stations 240-241, a printer 250 and/or one or more Access Point (APs) 260-262, which are electronic devices that provide bi-directional communications with one or more mobile stations (STAs) 270-271. For this embodiment, two (2) APs 261-262 communicate with two (2) STAs 270-271 as described below. The STAs 270-271 communicate with the APs 261-262 typically using a standardized protocol, such as an IEEE 802.11 based protocol or a HyperLAN2 protocol.

A “mobile station” (STA) is defined herein as any electronic product comprising (1) logic for processing information (e.g., a processor, microcontroller, state machine, etc.) and (2) a wireless transceiver for receiving information from and transmitting information to an AP or another mobile station. As shown, for instance, the electronic product may be a wireless handset, a pager or perhaps a facsimile machine or computer.

As shown in FIG. 2, media adapters 280-288 are coupled to the power line 210 and may be employed externally from a networking device or its functionality integrated therein. Normally, such coupling to the power line 210 is through a power adapter mounted in a wall of a facility (e.g., AC power outlet). The implementation of media adapters 280-288 avoids the necessity of additional wiring by capitalizing on an existing power line 210 and power line networking technologies for the transport of packets containing voice (and/or data) payloads. Moreover, since the facility already has several (AC) power outlets placed throughout, various networking devices can be connected at virtually any location in the facility where there are common power outlets.

Each media adapter 280-288 provides inter-working and adaptation to different media types. For example, power line networking can be employed on one side and Ethernet on the other. From a connectivity point of view, this is useful for a residential application, giving a lot of flexibility and benefit to the user in terms of convenient location of networking devices.

II. MAC and Inter-Working

Referring to FIG. 3A, the logical representations of embodiments of the gateway 225 and different types of media adapters 283, 286 and 287 is shown. Herein, for this embodiment, the gateway 225 features a physical layer 310 that is communicatively coupled to a selected transport medium 300 (e.g., broadband medium such as any type of Direct Subscriber Line “xDSL”, cable, etc.). Access to information propagating through the selected transport medium 300 is controlled by a Medium Access Control (MAC) layer 315. Such control may be in accordance with any IEEE MAC standard such as CSMA/CD (IEEE 802.3), Token Passing Bus (IEEE 802.4), Token Passing Ring (IEEE 802.5), Metropolitan Area Network (IEEE 802.6) or even wireless LANs (IEEE 802.11). This information is translated from a first format or packet structure (xDSL packets) to a second format or packet structure (packets for HomePlug frames) by a first inter-working unit (IWU1) 320.

Herein, for this embodiment, the IWU1 320 is responsible for assisting the Medium Access Control (PL MAC) layer 325, which is associated with the power line 210, to produce one or more packets. For one embodiment, the content of the packet(s) may be loaded into one or more frames such as a “HomePlug frames” in accordance with current or future HomePlug™ standards such as “HomePlug 1.0 Specification” published on or around Jun. 30, 2001 for example and incorporated by reference. Of course, the packet(s) may be configured in another packet structure. A HomePlug frame is routed via a power line physical (PL PHY) layer 330 to the power line 210 for transmission to other networking devices.

For instance, a HomePlug frame may be routed to media adapter 287 coupled to Access Point 261 as previously shown in FIG. 2. In accordance with OSI architecture, a logical representation of the media adapter 287 includes a physical layer 335 and a power line (PL) MAC layer 340 to enable the media adapter 287 to access routed HomePlug frames. These frames would be subsequently routed to a second IWU (IWU2) 345, which operates in conjunction with a MAC layer 350 and physical layer 355 of another transport medium (e.g., Ethernet such as 10Base-T, 100Base-T, Gigabit Ethernet and the like) to convert the accessed information into another packet structure (e.g., Ethernet frames). These Ethernet frames are routed to a peripheral device or Access Point 261 as shown.

Alternatively, the HomePlug frame may be routed from the power line 210 to the media adapter 283 as generally shown in FIG. 2 as well. In this embodiment, the media adapter 283 is coupled to the power line 210 at one end and the POTS telephone station 240 at the other end, normally through a RJ-11 jack. In accordance with OSI architecture, the media adapter 283 includes a power line physical (PL PHY) layer 360 and a power line (PL) MAC layer 365 to enable the media adapter 283 to access routed HomePlug frames. These frames would be subsequently routed to a voice gateway 370 and a POTS interface 375 for conversion into necessary signaling for operation of the POTS telephone station 240.

Yet another example, a HomePlug frame may be routed to a networking device having the functionality of a media adapter integrated therein such as the Access Point 260 for example. Hence, a logical representation of the Access Point 260 includes a power line physical (PL PHY) layer 380 and a PL MAC layer 385 to enable the Access point 260 to receive and transmit HomePlug frame(s) over power line 210. Upon receiving the HomePlug frame(s), they would be subsequently routed to a third IWU (IWU3) 390, which operates in conjunction with a radio frequency (RF) MAC layer 395 and physical layer 396 for providing RF signaling for transmission from the Access Point 260.

Referring now to FIG. 3B, an exemplary embodiment of a flowchart of the operations of the media adapter of FIG. 3A is shown. To transmit data from a networking device to a power line, an inter-working unit (IWU) receives one or more incoming frames from the networking device (block 400). For instance, the IWU may receive one or more Ethernet packets from logic situated in the networking device (e.g., Ethernet controller). The IWU then analyzes the type of frame(s) received from the networking device (block 405). Upon analysis, if the frame involves user data (e.g., an Address Resolution Protocol “ARP” request, management, etc.), the IWU accesses an internal translation table to determine if a translation entry is available for the incoming frame (e.g., a ARP request frame) as shown in blocks 410 and 415. If so, the IWU provides additional header and control information for attachment to the incoming frame (blocks 420 and 425). For instance, the contents of each translation entry may include a destination Ethernet address, a destination PL MAC address and a source PL MAC address, the later being filled upon generation of a ARP request frame.

As an illustrative example for the additional header and control information, the IWU may provide additional header information to the PL MAC layer, including one or more of the following: a power line designation MAC address, a power line source MAC address, type/length, and/or optional MAC management information (e.g., channel estimation, encryption key). The payload would include the incoming frame and the control information may include a checksum or other information involving error correction code. The IWU also updates entries of the internal translation table with information received from ARP request or ARP response frames as described below.

As an optional feature as shown in block 420, the frame and additional header information may be stored into internal memory (e.g., a power line output buffer) within the media adapter that is accessible by the IWU and/or the PL MAC layer (block 420). Of course, if the power line output buffer is full, memory management operations may be performed depending on the priority of the incoming translated frame. Alternatively, the incoming frame and additional header information may be provided directly to the PL MAC layer (block 425). Based on this information, the PL MAC layer assembles HomePlug frame(s) for transmission over the power line (block 430).

In the event that a translation entry is not available for the incoming frame type, the IWU generates an interrupt for logic within the media adapter and the IWU processes the incoming frame, begins to build a translation entry in the translation table by before sending the incoming frame to the PL MAC layer (block 435).

In order to route information from the power line to the networking device via the media adapter, the IWU will receive a packet from the PL MAC layer and perhaps via an optional power line input buffer located in the internal memory of the media adapter (blocks 450 and 455). The IWU will analyze the packet to determine its type (block 460). The analysis may prompt an interrupt from the IWU to handle the packet processing accordingly.

For example, if the packet type is voice (e.g., a type other than user data such as an ARP response frame), the IWU activates a voice processing task and routes the processed information to a POTS driver associated with a telephone (blocks 465 and 470). If the packet type is user data, the IWU will perform necessary processing by updating a corresponding entry of the internal translation table (e.g., load contents from the source PL MAC address as well as the source Ethernet address contained in payload of ARP response frame as “destination PL MAC address” and “destination Ethernet MAC address”, respectively) before sending the data to the Ethernet controller of the computer (blocks 475 and 480).

III. Illustrative Examples

A. Network Architecture

The following provides a detailed network architecture of a wireless solution using a wireless LAN protocol (e.g., IEEE 802.11) and the HomePlug™ standard.

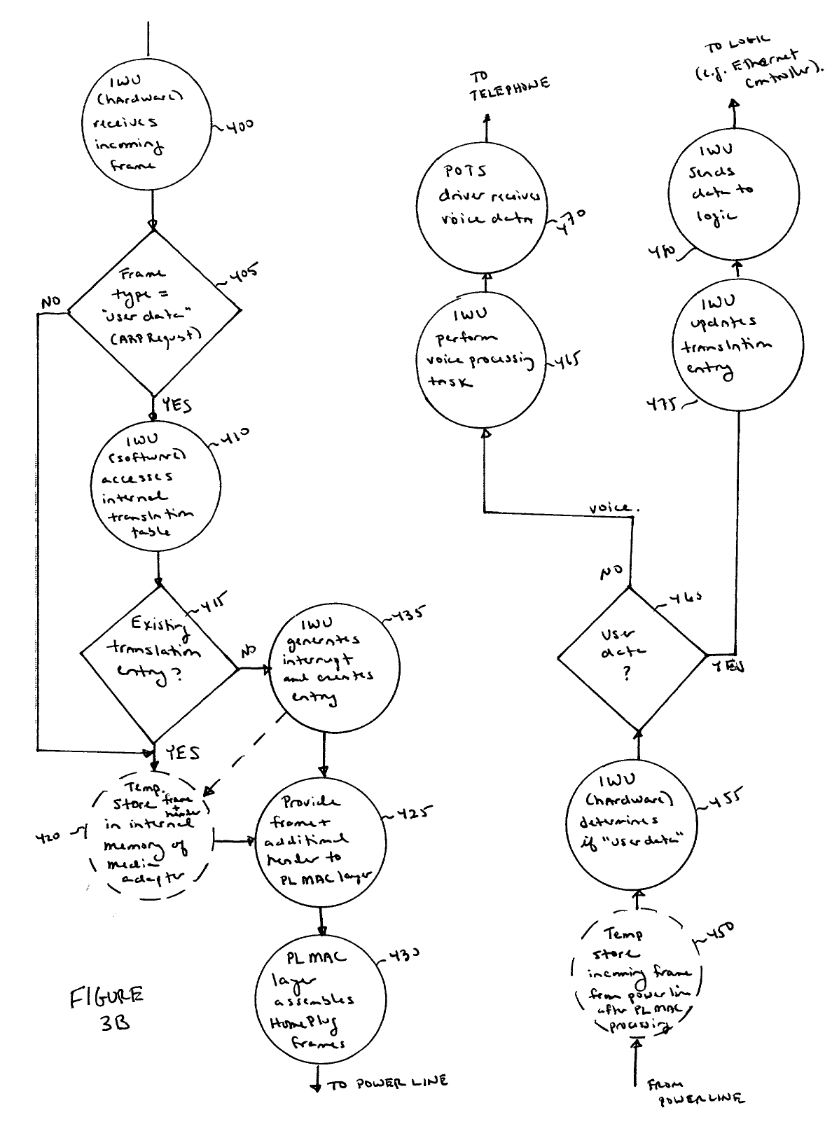

Referring now to FIG. 4, AP1 400 and AP2 410 are Access Points, which give wireless (radio) access to the mobile stations (labeled “STA”) in their respective coverage areas 420 and 425, respectively. The coverage areas 420 and 425 are typically referred to as Basic Service Set “BSS” (e.g., BSS1 420 and BSS2 425). AP1 400 and AP2 410 also provide access to a distribution system 440 to enable Inter-BSS roaming for the mobile stations.

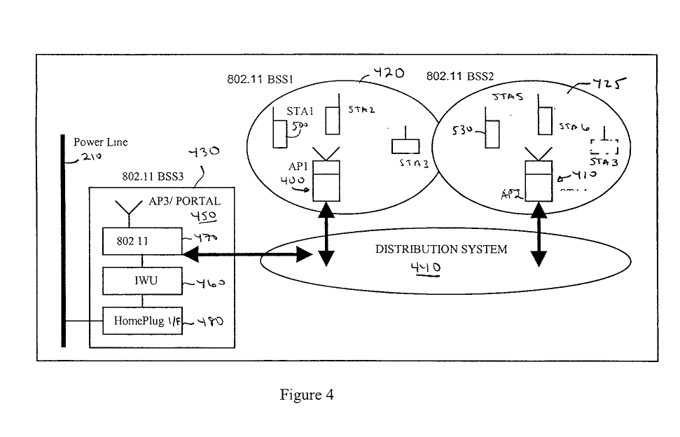

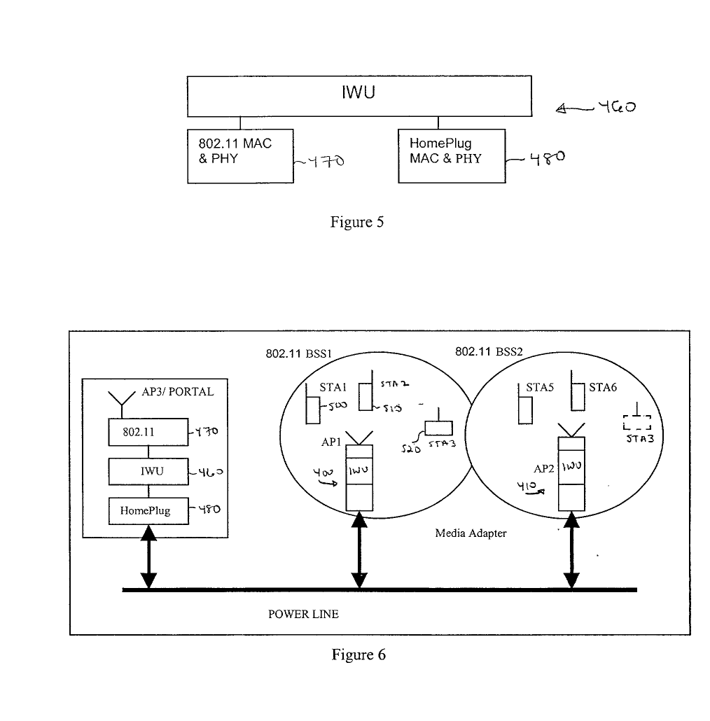

AP3 450 is another Access Point, which gives wireless (radio) access to the mobile stations in its coverage area (BSS3) 430. AP3 450 provides access to the distribution system 440 to enable Inter-BSS roaming for the mobile stations. AP3 450 also provides the services of a portal by connecting to the Wired LAN network based on a wired backbone (e.g., power line 210) over interface 480 in accordance with the HomePlug™ standard (hereinafter referred to as the “HomePlug interface 480”). The HomePlug interface 480 is equivalent to PL PHY and PL MAC layers. The distribution system 440 is based on an 802.11 infrastructure or an ad-hoc network that communicatively couples Access Points in different BSS areas. To simplify the networking between multiple access points, the distribution system 440 for AP1 400, AP2 410 and AP3 450 can also be based on the HomePlug™ interface as shown in FIG. 6. For this embodiment, an IWU 460 (shown in FIG. 5) is needed to enable information handling between a network operating in accordance with IEEE 802.11 and a HomePlug™ network.

As an aside, when a gateway function is incorporated into the portal (e.g. xDSL access to a broadband network), a router function will be required at the network layer.

B. Operation Scenario 1

A first mobile station (STA1) 500 calls another mobile station (STA2) 510. Both stations 500 and 510 remain in the same coverage area (BSS1 420) for the whole duration of the call. In this scenario, the STA1 500 will connect to STA2 510 through the AP1 400. AP1 400 routes the information between STA1 500 and STA2 510. The IEEE 802.11 MAC layer for AP1 400 handles the call and no IWU is required.

C. Operation Scenario 2

A third mobile station (STA3) 520 sets up a connection to access information over the Internet. The STA3 520 remains in the same area (BSS1 420) during the entire session. For this scenario, the STA3 520 will connect to AP1 400. The AP1 400 routes the information to AP3 450 over the distribution system 440. In one embodiment, the distribution system 440 is based on 802.11 standard, hence no IWU is required on the AP1 400.

However, with respect to FIG. 6, the distribution system 440 is based on the HomePlug™ standard. Hence, an inter-working unit between 802.11 and HomePlug™ is required on AP1 400, which does the required protocol conversion between the two standards. The AP1 400 should have enough buffer space to be able to fill the bandwidth/speed gap between the HomePlug™ and the IEEE 802.11 networks.

For both embodiments illustrated in FIGS. 4 and 6, an IEEE 802.11 interface 460 in the AP3 450 takes the packet and passes it on to an IWU 470. The IWU 470 does the proper translation and pass the information to the HomePlug™ interface 480 for transmission over the power line 210 to a gateway and on to the external world.

D. Operation Scenario 3

As shown in FIG. 4, STA1 500 calls another mobile station STA5 530. Both stations 500 and 530 remain in their respective coverage area for the whole duration of the call. In this scenario, the STA1 500 will connect to AP1 400. The AP1 400 routes the information to AP2 410 over the distribution system 440. The AP2 410 routes the call information to the STA5 530. Herein, no IWU is needed as the distribution system 440 is based on the IEEE 802.11 standard. As shown in FIG. 6, however, an IWU is needed to enable information handling between IEEE 802.11 and the HomePlug™ standards.

E. Operation Scenario 4

A mobile station (STA3) 520 sets up a connection to access information over the Internet. The STA3 520 moves to an area serviced by AP2 during the connection as represented by dashed lines. More specifically, for this scenario, the STA3 520 will connect to the AP1 400. The AP1 400 routes the information to AP3 450 over the distribution system 440. The IEEE 802.11 Interface 470 in the AP3 450 takes the packet and passes it on to the IWU 460. The IWU 460 does the proper translation and pass the information to the HomePlug™ interface 480 to be transmitted over the power line 210 to a gateway and on to the external world.

When STA3 520 moves to a different BSS (e.g., from BSS1 420 to BSS2 430) as represented by dashed lines, it associates itself with AP2 410 and now the AP2 410 routes the information to AP3 450 over the distribution system 440. The IEEE 802.11 interface 470 in the AP3 450 takes the packet and passes it on to the IWU 460. The IWU 460 does the proper translation and pass the information to the HomePlug™ interface 480 for transmission over the power line 210.

In FIG. 4, the IEEE 802.11 based network interfaces to the HomePlug™ network only at AP3 450. The distribution system 440 associated with AP1 400, AP2 410 and AP3 450 is based on IEEE 802.11 standard. The IEEE 802.11 MAC standard supports the message formats between the APs, thus reducing the complexity of the network. However, it might be the case that one runs into limited range problem with the IEEE 802.11 based distribution system. Moreover this architecture requires cell planning.

In FIG. 6, the IEEE 802.11 based network interfaces to the HomePlug™ network at all the Access Points (e.g., AP1 400, AP2 410 and AP3 450). However, only the AP3 450 acts as a portal. The distribution system 440 of the network is based on HomePlug™ interface, thus requiring IWUs at all the Access Points (AP1 400, AP2 410 and AP3 450).

The complexity of the MAC layer and IWU is much more in the gateway because there the MAC layer logic will receive data packets containing information from different networks. The MAC layer logic will have to analyze information by extracting a type of information from the HomePlug frame and passing the information along with data to indicate information type on to the IWU for protocol translation. The complexity of the gateway and the media adapters will be enhanced if it supports multiple wireless protocols like Bluetooth, HyperLAN2 and the like.

Other than the wireless protocols, the HomePlug™ network could also interface to the POTS (Plain Old Telephone Service). In this case, there would be an inter-working unit in the media adapters, which would supply/extract signaling information and speech information to/from the HomePlug™ network.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. For example, it may be possible to implement the invention or some of its features in hardware, firmware, software or a combination thereof.

What is claimed is:

1. A media adapter for coupling a networking device to a power line, the media adapter comprising:
a physical layer to be coupled to the power line;
a medium access control (MAC) layer in communication with the physical layer; and
an inter-working unit in communication with the MAC layer, the inter-working unit to translate information from a first format into a second format differing from the first format to enable information to be received and transmitted over the power line.

2. The media adapter of claim 1, wherein the power line is electrical wiring supporting an alternating current.

3. The media adapter of claim 1, wherein the inter-working unit translates voice routed over at least one HomePlug frame into audio signals recognized by a Plain Old Telephone System (POTS) interface.

4. The media adapter of claim 1, wherein the inter-working unit translates data routed over at least one HomePlug frame into data placed in an Ethernet frame.

5. The media adapter of claim 4, further comprising a medium access control (MAC) layer and a physical layer to support Ethernet-based communications.

6. The media adapter of claim 5, further comprising an access point coupled to the physical layer supporting Ethernet-based communications, the access point to transmit signal to the networking device over a wireless communication path.

7. The media adapter of claim 1, wherein the inter-working unit translates voice routed over at least one HomePlug frame into radio frequency signals transmitted by a transceiver integrated within the media adapter.

8. A network comprising:
an alternating current (AC) power line;
a gateway in communication with the AC power line, the gateway including a first inter-working unit to translate information of a first format received from a remote source into information of a second format configured for transport over the AC power line; and
a media adapter in communication with the AC power line, the media adapter including a second inter-working unit to translate the information of the second format into information of a third format.

9. The network of claim 8, wherein the information of the first format is data transmitted over any type of Digital Subscriber Line (xDSL).

10. The network of claim 9, wherein the information of the second format is data transmitted through one or more HomePlug frames.

11. The network of claim 10, wherein the information of the third format is data transmitted in accordance with an Ethernet format.

12. The network of claim 8, wherein the first inter-working unit is software executed by a processor that translates extracts payload data from a HomePlug frame and produces a packet for transmission in accordance with a Wireless Local Area Network (WLAN) standard.

13. A method comprising:
receiving at least one frame containing information transmitted over a power line;
extracting information from the frame, the information being in a first format;
translating the information from a first format into a second format; and
transmitting the information having the second format to a networking device.

14. The method of claim 13, wherein the frame is a HomePlug frame.

15. The method of claim 13, wherein the information is voice.

16. The method of claim 13, wherein the information having the second format is at least one Ethernet packet that differs in data structure from the information having the first format.

17. The method of claim 13, wherein the information having the second format is radio frequency (RF) signaling that differs in data structure from the information having the first format.

18. The method of claim 13, wherein the power line is alternating current electrical wiring.

19. A software stored in a machine readable medium for execution by a processor, the software module comprising:
a first software module to recover information from an incoming frame routed over a power line, the information being in a first format;
a second software module to translate multiple types of information from a first format into a second format; and
a third software module to transmit the translated information having the second format to a networking device.

20. The software of claim 19, wherein the second software module is adapted to translate both (i) data and (ii) voice carried over the power line.
